(19) United States
(12) Patent Application Publication
(10) Pub. No.: US 2021/0015231 A1
(43) Pub. Date: Jan. 21, 2021

(54) MELAMINE FOAM HAIR APPARATUS

(71) Applicant: Gary Grey, New York, NY (US)

(72) Inventor: Gary Grey, New York, NY (US)

(21) Appl. No.: 17/064,263

(22) Filed: Oct. 6, 2020

Related U.S. Application Data
(63) Continuation of application No. 15/702,475, filed on Sep. 12, 2017.
(60) Provisional application No. 62/393,240, filed on Sep. 12, 2016.

(51) Int. Cl. A45D 2/00; A45D 7/00; A45D 7/04

(52) U.S. Cl. CPC A45D 2/001; C08G 12/32; A45D 7/04; A45D 7/00

(57) ABSTRACT

Exemplary embodiments of a hair straightening apparatus are provided. For example, a hair straightening apparatus can be provided including a first foam section including a melamine foam material, the first foam section having a first surface and a second surface opposite the first surface, a second foam section including a melamine foam material, the second foam section having a first surface and a second surface opposite the first surface, and a flexible middle portion provided between the first foam section and second foam section, wherein the first foam section and second foam section are configured to be pressed together and rotatable around the flexible middle portion.

### CROSS-REFERENCE TO RELATED APPLICATIONS

This application relates to and claims priority from U.S. Provisional Patent Application Ser. No. 62/393,240 filed Sep. 12, 2016, the entire disclosure of which is hereby incorporated herein by reference.

### FIELD OF THE DISCLOSURE

The present disclosure relates to exemplary embodiments of a hair apparatus for reducing hair frizz, smoothing hair and straightening hair, and more particularly, to exemplary embodiments of a hair apparatus utilizing a melamine foam material for reducing hair frizz, smoothing hair and straightening hair.

### BACKGROUND INFORMATION

A variety of different devices and methods may be used for straightening hair. For example, a user may employ a hairbrush to place tension on his or her hair while applying heated air with a hair dryer. The user can also use a styler/dryer appliance that can have various styling attachments, such as a brush or a comb, which attach to the nozzle of the hair dryer, and typically having an elongated body with a head portion in which the hot air flow exits laterally therefrom. Thus, the appliance can be manipulated in the same fashion as a common brush, namely one's hair being dried and styled as the user merely brushes or combs his or her hair. Hair can also be straightened by applying a relaxing agent to break down the natural curls of the hair. A hair dryer is then typically used to dry the hair and, in some cases, provides the requisite heat necessary to activate the relaxing agent. A curling iron or similar device may facilitate straightening of hair by compressing the hair between flat surfaces of heated iron.

However, these devices and methods are two-handed procedures that require agility, concentration, and manipulation of a device and comb, and thus can be strenuous and tiresome for the user. Further, most of these devices require an electrical outlet or a battery to provide power to the device, which may be additional hassles for the user.

### SUMMARY OF EXEMPLARY EMBODIMENTS OF THE DISCLOSURE

At least some of the above described problems can be addressed by exemplary embodiments of the apparatus according to the present disclosure. Exemplary embodiments of a melamine foam hair apparatus are provided for straightening a user's hair.

In some exemplary embodiments, a hair straightening apparatus is provided, comprising a first foam section comprising a melamine foam material, the first foam section having a first surface and a second surface opposite the first surface, a second foam section comprising a melamine foam material, the second foam section having a first surface and a second surface opposite the first surface, and a flexible middle portion provided between the first foam section and second foam section, wherein the first foam section and second foam section are configured to be pressed together and rotatable around the flexible middle portion.

The hair straightening apparatus can further comprise a cover provided around the second surface of the first foam section and the second surface of the second foam section. In some exemplary embodiments, the second surface of the first foam section and the second surface of the second foam section are fixed to the cover. In some exemplary embodiments, the second surface of the first foam section and the second surface of the second foam section are detachably connected to the cover.

The hair straightening apparatus can further comprise a first pocket within the cover to receive a portion of the first foam section, and a second pocket within the cover to receive a portion of the second foam section. In some exemplary embodiments, the first foam section and the second foam section can have a rectangular shape. In some exemplary embodiments, the flexible middle portion comprises a spring mechanism to bias the first surface of the first foam section away from the first surface of the second foam section. In some exemplary embodiments, the spring mechanism provides 180 degree rotation between the first foam section and the second foam section. In some exemplary embodiments, the entire first foam section and the entire second foam section comprise a melamine foam material.

The hair straightening apparatus can further comprise a handle connected to the flexible middle portion, and a sliding section provided on the handle configured to press the first foam section and the second foam section together in a first position and away from each other in a second position.

In some exemplary embodiments, a method of straightening hair is provided, comprising pressing a first foam section comprising a melamine foam material against a second foam section comprising a melamine foam material, wherein a user's hair is pressed between the first foam section and the second foam section to straighten the user's hair, wherein the first foam section and second foam section are configured to be pressed together and rotatable around the flexible middle portion by the user. In some exemplary embodiments, the first foam section and second foam section are biased away from each other by the flexible middle portion.

### BRIEF DESCRIPTION OF THE DRAWINGS

The foregoing and other objects of the present disclosure will be apparent upon consideration of the following detailed description, taken in conjunction with the accompanying drawings and claims, in which like reference characters refer to like parts throughout, and in which:

FIG. 1 is an illustration of a perspective view of a hair apparatus according to an exemplary embodiment of the present disclosure;

FIG. 2 is an illustration of a middle flexible portion of a hair apparatus according to an exemplary embodiment of the present disclosure;

FIG. 3 is an illustration of a perspective view of the hair apparatus being used on hair according to an exemplary embodiment of the present disclosure; and

FIG. 4 is an illustration of a spring mechanism provided as a middle flexible portion of a hair apparatus according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

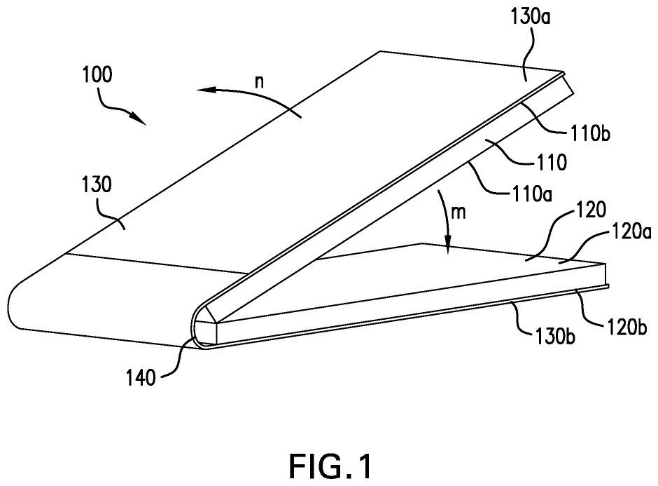

FIG. 1 is an illustration of a perspective view of a hair apparatus 100 according to an exemplary embodiment of the present disclosure. The hair apparatus 100 can have a first foam section, such as a first foam pad 110 and a second foam section, such as a second foam pad 120. In some exemplary embodiments, the first foam pad 110 and second foam pad 120 can be made from a melamine foam material, a foam-like material including a formaldehyde-melamine-sodium bisulfite copolymer, or a composite material containing a portion of melamine foam material. The first foam pad 110 and second foam pad 120 can be of any shape, thickness, length or width. In some exemplary embodiments, the first foam pad 110 and second foam pad 120 can be rectangular foam pads, or can be but are not limited to any other shape, such as square, circular, oval, triangular or other polygonal shapes. In some exemplary embodiments, the first foam pad 110 can have a first surface 110a and a second surface 110b opposite the first surface 110a, and the second foam pad 120 can have a first surface 120a and a second surface 120b opposite the first surface 120a.

In some exemplary embodiments, a cover or back 130 can be provided around an exterior of the first foam pad 110 and second foam pad 120, as shown in FIG. 1. The cover or back 130 can cover the second surface 110b of the first foam pad 110 and the second surface 120b of the second foam pad 120. The first foam pad 110 and second foam pad 120 can be attached to the back 130, can be unitary with the back 130, or can be removably attached to the back 130. In some exemplary embodiments, the first foam pad 110 and second foam pad 120 can be glued or sealed to the back 130. In some exemplary embodiments, the back 130, the first foam pad 110 or the second foam pad 120 can be detachably connected and can be replaceable. In some exemplary embodiments, pockets can be provided along an inner portion of the back 130 such that a portion of the first foam pad 110 and second foam pad 120 can be provided within the pockets to secure the first and second foam pads within the cover 130

The cover or back 130 can be made of any material, such as but not limited to paper, plastic, metal, glass or any composite of these materials. A flexible middle portion 140, such as a hinged portion, can be provided on the cover 130 so that the hair apparatus 100 can bend at the flexible middle portion 140. The cover 130 can have a first cover portion 130a that can be provided along the first foam pad 110 and a second cover portion 130b that can be provided along the second foam pad 120, such that the flexible middle portion 140 is provided between the first cover portion 130a and the second cover portion 130b. In some exemplary embodiments, the flexible middle portion 140 can bend so that the first foam pad 110 and second foam pad 120 can be pushed against each other in a direction m, and separated from each other in a second direction n, as will be further explained below.

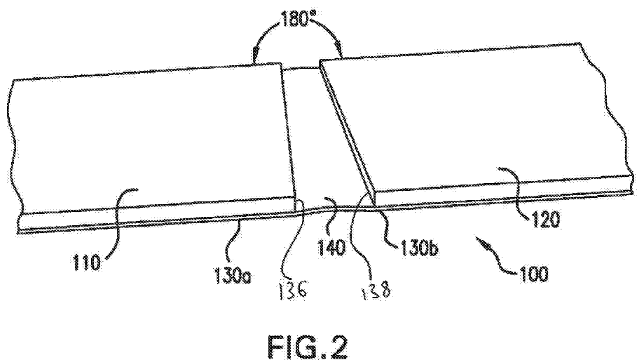

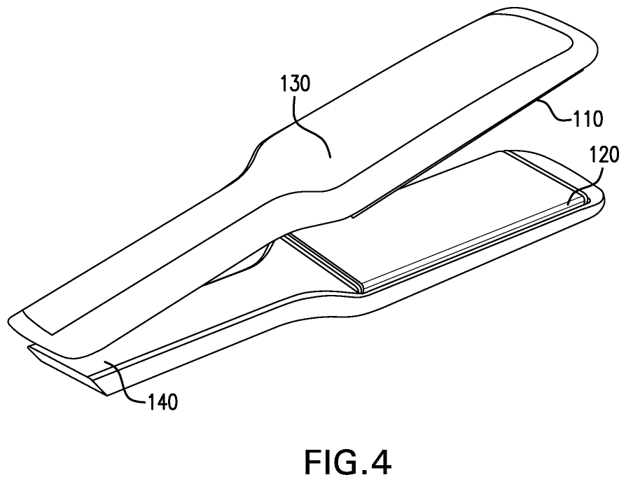

FIG. 2 is an illustration of a middle flexible portion 140 of a hair apparatus 100 according to an exemplary embodiment of the present disclosure. As shown in FIG. 2, the flexible middle portion 140 can allow the foam pads 110, 120 of the hair apparatus 100 to separate from each other such that there is, e.g., a 180 degree separation between the first foam pad 110 and second foam pad 120. In some exemplary embodiments, the flexible middle portion 140 can extend past 180 degrees and is not limited to any particular angle. The flexible middle portion 140 can be unitary with the cover 130, or can be a separate portion provided connecting the first cover portion 130a and second cover portion 130b, such as a hinge, spring, bracket or other flexible mechanism. In some exemplary embodiments, as shown in FIG. 4, a spring mechanism can be provided as the flexible middle portion 140 between the first foam pad 110 and the second foam pad 120 such that the hair apparatus 100 is biased to an open position (i.e., pushing the foam pads 110, 120 in a direction away from each other).

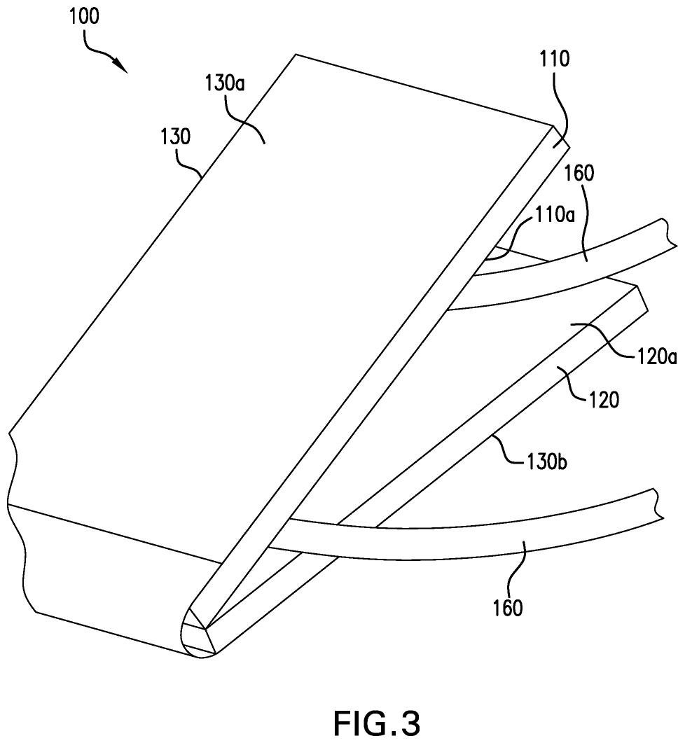

FIG. 3 is an illustration of a perspective view of a hair apparatus 100 being used to remove fizz, smooth hair or straighten hair 160 according to an exemplary embodiment of the present disclosure. As shown in FIG. 3, a user can hold the hair apparatus 100 with a single hand, pressing one or more fingers (e.g., a thumb) against the first cover portion 130a and one or more fingers (e.g., remaining four fingers) against the second cover portion 130b. The user can press one or more hairs 160 between the first foam pad 110 and the second foam pad 120, such that the user's hair is placed between the first surface 110a of the first foam pad 110 and the first surface 120a of the second foam pad 120. In some exemplary embodiments, a user can begin pressing one or more hairs 160 at or near the root of the hair 160 and slide the hair apparatus 100 to the tip of the hair 160, which can help to remove any frizz, smooth hair and/or straighten the hair 160. The hair 160 can be pressed several times where there is more hair frizz, such as at the ends of the hair 160, or greater smoothing or straightening is desired. A spring mechanism can be provided within the flexible middle portion 140 such that when a user is done pressing one or more hairs, the hair apparatus 100 automatically opens up so that the user can use the hair apparatus 100 to press more hair 160.

Various other considerations can also be addressed in the exemplary applications described according to the exemplary embodiments of the present disclosure. For example, various materials may be used to construct the elements described in the figures, such as the cover 130 and the first and second foam pads 110, 120. Melamine foam or other types of foams may be used as the foam pad material for the first and second foam pads 110, 120. Various sizes and dimensions of the elements can be provided, as well as shapes for the cover 130 and the first and second foam pads 110, 120. A lighting mechanism can be added that lights when the first foam pad and second foam pad are separated from each other to allow the user to see their hair as they use the apparatus.

In some exemplary embodiments, a handle can be provided on the hair apparatus 100, which can be connected to the hair apparatus 100 along the middle portion 140. A sliding switch or mechanism can be provided on the handle that allows the user to open and close the hair apparatus 100 (i.e., press the foam pads against each other in a first position and away from each other in a second position) to trap and release the hair 160 between the first and second foam pads 110, 120. Various logos or designs can be provided on the cover 130. The foam pads 110, 120 can be infused with conditioners, straighteners, vitamins or minerals allowing treatment of hair or hair cuticles when pressed between the foam pads 110, 120. Another embodiment can place the foam pads on or around a handle similar to a hairbrush. The handle can be used similarly to a brush or comb and pressed against the hair. A further embodiment is a method of reducing or removing hair fizz, smoothing hair or straightening hair by rubbing a foam pad made from a melamine foam material, a foam-like material consisting of a formaldehyde-melamine-sodium bisulfite copolymer, or a composite material containing a portion of melamine foam material.

Various advantages are provided in the hair apparatus 100 according to the exemplary embodiments of the present disclosure. For example, the hair apparatus 100 can allow a user to treat their hair without harsh chemicals or heat to remove the frizz from their hair that can damage the hair or hair cuticles, promoting smoother and healthier hair. Further, there is no battery or electrical connection required allowing the user to use the hair apparatus 100 at any time and location. The hair apparatus 100 can be portable and compact, allowing it to conveniently fit in a handbag or pocket. The hair apparatus 100 can be water resistant, and can be shaped to fit comfortably and be used in either the left or right hand. In some exemplary embodiments, the hair apparatus can be a single unitary foam material (e.g., melamine foam) that can bend along a middle portion, and may not have a cover portion.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure.

1. A hair smoothing apparatus consisting of:
a first foam section made of a melamine foam material, the first foam section having a first surface and a second surface opposite the first surface;
a second foam section made of a melamine foam material, the second foam section having a first surface and a second surface opposite the first surface; and
a flexible middle portion provided between the first foam section and second foam section;
wherein the first foam section and second foam section are configured to be pressed together and drawn across a user's hair to smooth the hair, and rotatable around the flexible middle portion.

2. The hair smoothing apparatus according to claim 1, further consisting of:
a cover provided around the second surface of the first foam section and the second surface of the second foam section.

3. The hair smoothing apparatus according to claim 2, wherein the second surface of the first foam section and the second surface of the second foam section are fixed to the cover.

4. The hair smoothing apparatus according to claim 2, wherein the second surface of the first foam section and the second surface of the second foam section are detachably connected to the cover.

5. The hair smoothing apparatus according to claim 2, further consisting of:
a first pocket within the cover to receive a portion of the first foam section; and
a second pocket within the cover to receive a portion of the second foam section.

6. The hair smoothing apparatus according to claim 1, wherein the first foam section and the second foam section have a rectangular shape.

7. The hair smoothing apparatus according to claim 1, wherein the flexible middle portion includes a spring mechanism to bias the first surface of the first foam section away from the first surface of the second foam section.

8. The hair smoothing apparatus according to claim 7, wherein the spring mechanism provides 180 degree rotation between the first foam section and the second foam section.

9. The hair smoothing apparatus according to claim 1, wherein the entire first foam section and the entire second foam section is made of a melamine foam material.

10. A method of straightening hair, consisting of:
pressing a first foam section made of a melamine foam material against a second foam section made of a melamine foam material, wherein a user's hair is pressed between the first foam section and the second foam section, and the first foam section and the second foam section are drawn across the hair;
wherein the first foam section and second foam section are configured to be pressed together and rotatable around a flexible middle portion provided between the first foam section and the second foam section by the user.

11. The method of straightening hair according to claim 10, wherein the first foam section and second foam section are biased away from each other by the flexible middle portion.
